(19) United States
(12) Patent Application Publication
(10) Pub. No.: US 2026/0109307 A1
(43) Pub. Date: Apr. 23, 2026

(54) PERIPHERAL POWER MODULE FOR PERSONAL ELECTRIC VEHICLES

(71) Applicants: Harrison Lu, Costa Mesa, CA (US); Tyler W. Rowan, El Segundo, CA (US)

(72) Inventors: Harrison Lu, Costa Mesa, CA (US); Tyler W. Rowan, El Segundo, CA (US)

(21) Appl. No.: 18/924,036

(22) Filed: Oct. 23, 2024

(51) Int. Cl. B60R 16/023; B60R 16/03; H02J 1/04; H02J 7/00

(52) U.S. Cl. CPC B60R 16/0238; B60R 16/03; H02J 1/04; H02J 7/855; H02J 2105/37; H02J 2207/20

(57) ABSTRACT

An electrical bicycle electrical system includes a battery, various accessories and an electrical power distribution module. The electrical power distribution module includes a control device, various accessory modules and a voltage convertor module. The electrical power distribution module operates to convert the bicycle battery voltage to the corresponding voltages of the bicycle accessories which are commonly lower than the battery voltage. The electrical power distribution module adapts to a variety of different bicycles, manufactured by different manufacturers, allowing users to replace the manufacturer's engine control unit to fit their application.

### COPYRIGHT

A portion of the disclosure of this patent document contains material which is subject to copyright protection. The owner has no objection to the facsimile reproduction by anyone of the patent disclosure, as it appears in the Patent and Trademark Office files or records, but otherwise reserves all copyright rights whatsoever.

### FIELD OF INVENTION

The present invention relates to an electric bicycle electrical system comprising an electrical power distribution module and a method of operation. The electrical system includes a battery, various accessories and an electrical power distribution module which comprises an intelligent control device. A voltage convertor module and various accessory modules are also included in the electrical power distribution module to convert the high voltage of the battery to lower voltages suitable for the accessories. The electrical power distribution module senses the battery voltage and the voltages of the accessories and delivers electrical power to the corresponding accessories at converted voltages of the accessories.

### BACKGROUND

Current personal electric vehicles (PEVs), such as an electrical bicycle, often face inefficiencies in distributing power from the main battery to low-voltage accessories such as lights, indicators, and other peripherals. Existing approaches may require additional power sources or involve complicated wiring setups, resulting in operational inefficiencies, added complexity, and increased costs. To address this issue, there is a growing demand for an integrated power distribution module that simplifies the process, optimizes energy use, and enhances vehicle functionality by intelligently managing accessory power.

The present invention provides an electrical power distribution module which is included in a universal engine control unit. Users of PEVs, manufactured by different manufacturers, can use this universal engine control unit to replace the manufacturer's engine control unit to fit their application.

### SUMMARY

In one aspect, an electric bicycle electrical system is disclosed wherein the system comprises a battery operative to provide electrical power at a battery voltage to the electrical system, two or more accessories and an electrical power distribution module connected to and in communication with the battery and the two or more accessories, said electrical power distribution module comprising a control device, two or more accessory modules coupled with the two or more accessories and operative to provide electrical power to the two or more accessories at two or more accessory voltages, and a voltage convertor module, wherein the control device senses a battery signal from the battery indicative of the battery voltage, via a battery sense line, and two or more accessory signals from the two or more accessory modules indicative of the two or more accessory voltages, via two or more accessory sense lines, and converts the battery voltage to the two or more accessory voltages, via the voltage convertor module.

Preferably, the control device comprises a microprocessor, including a programming code operable on the microprocessor.

Preferably, the battery voltage is one of 48 volts, 52 volts, 60 volts, and 72 volts.

Preferably, the two or more accessories comprise a head light, a tail light, a brake, a left turn signal, a right turn signal and a horn.

Preferably the two or more accessory modules provide electrical power to the head light at 8 volts, to the tail light at 6 volts, to the brake at 10 volts, to the left turn signal at 4 volts, to the right turn signal at 4 volts, and to the horn at 12 volts.

In another aspect, an electrical power distribution module for an electric bicycle electrical system is disclosed wherein said electrical system comprises a battery operative to provide electrical power at a battery voltage to the electrical system and two or more accessories, wherein the electrical power distribution module is connected to and in communication with the battery and the two or more accessories, said electrical power distribution module comprises a control device, two or more accessory modules coupled with the two or more accessories and operative to provide electrical power to the two or more accessories at two or more accessory voltages, and a voltage convertor module, wherein the control device senses a battery signal from the battery indicative of the battery voltage, via a battery sense line, and two or more accessory signals from the two or more accessory modules indicative of the two or more accessory voltages, via two or more accessory sense lines, and converts the battery voltage to the two or more accessory voltages, via the voltage convertor module.

In another aspect, a method of controlling an electric bicycle electrical system is disclosed wherein said electrical system comprises a battery operative to provide electrical power at a battery voltage to the electrical system, two or more accessories, and an electrical power distribution module connected to and in communication with the battery and the two or more accessories, said electrical power distribution module comprising a control device, two or more accessory modules coupled with the two or more accessories and operative to provide electrical power to the two or more accessories at two or more accessory voltages, and a voltage convertor module, said method comprising sensing a battery signal from the battery indicative of the battery voltage, via a battery sense line, sensing two or more accessory signals from the two or more accessory modules indicative of the two or more accessory voltages, via two or more accessory sense lines, and converting the battery voltage to the two or more accessory voltages, via the voltage convertor module.

### DESCRIPTION OF THE DRAWINGS

FIG. 1 shows a block diagram of an electric bicycle electrical system comprising a battery, various accessories and an electrical power distribution module comprising a control device, various accessory modules and a voltage convertor module, wherein the control device senses a battery signal from the battery indicative of the battery voltage, via a battery sense line, and various accessory signals from the various accessory modules indicative of the various accessory voltages, via two or more accessory sense lines, and converts the battery voltage to the various accessory voltages, via the voltage convertor module according to a preferred embodiment.

FIG. 2 shows a block diagram of an electrical power distribution module wherein a control device utilizes a voltage convertor module to convert a battery voltage to various accessory voltages via various accessory modules according to a preferred embodiment.

FIG. 3 is a flow diagram of one preferred method of controlling an electric bicycle electrical system by sensing a battery signal from the battery indicative of the battery voltage, via a battery sense line, sensing various accessory signals from various accessory modules indicative of the various accessory voltages, via various accessory sense lines, and converting the battery voltage to the various accessory voltages, via the voltage convertor module according to a preferred embodiment.

### DETAILED DESCRIPTION OF THE PRESENTLY PREFERRED EMBODIMENTS

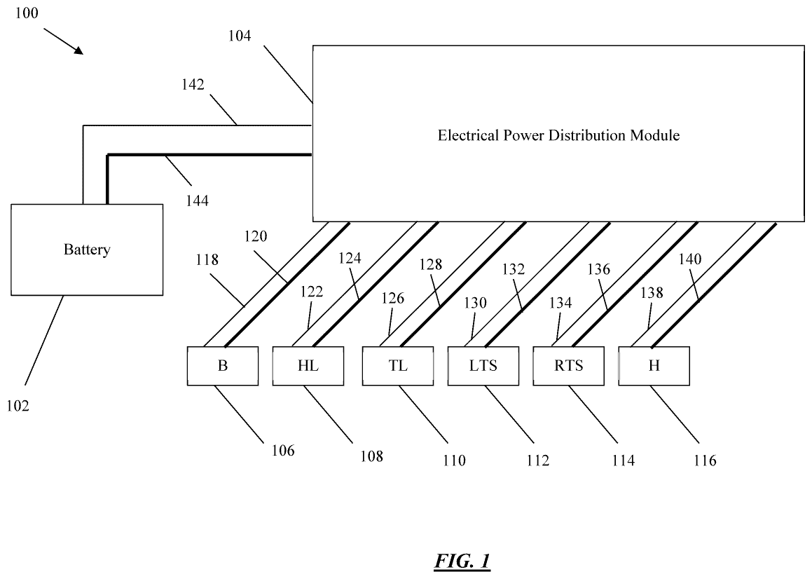

FIG. 1 depicts a block diagram of an electric bicycle electrical system 100 according to a preferred embodiment. The electrical system 100 includes a battery 102, an electrical power distribution module 104 and various accessories, 106, 108, 110, 112, 114 and 116. In this preferred embodiment, there are six accessories, namely, a brake at 106, a headlight at 108, a tail light at 110, a left turn signal at 112, a right turn signal at 114 and a horn at 116.

The battery 102 provides electrical power via a line 144 at a battery voltage to the electrical system 100. The battery voltage may vary and depends on the electrical vehicle. Typical battery voltage for personal electric vehicles ranges from 24 volts to 100 volts. In a preferred embodiment, the battery 102 is a lithium battery.

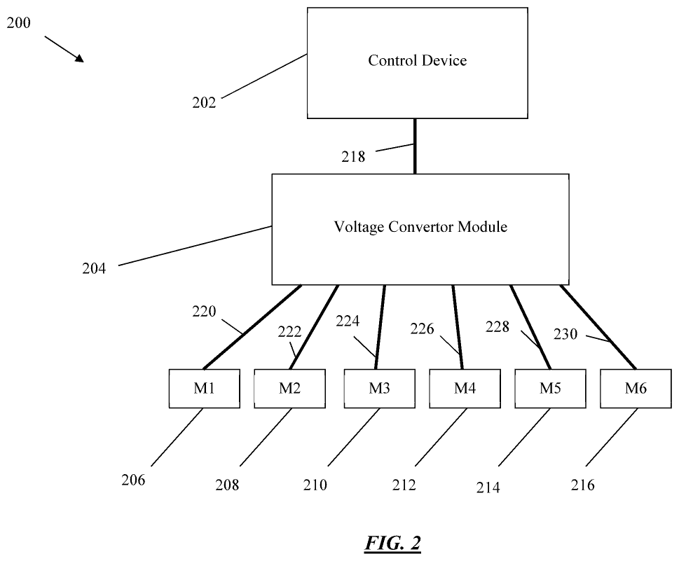

The electrical power distribution module 104 includes a control device, a voltage convertor module and various accessory modules (not shown but see FIG. 2). The electrical power distribution module 102 comprises one or more integrated circuits (ICs) and various discrete components laid on a printed circuit board (PCB) which is integrated within the vehicle's engine control unit (ECU).

The various accessories, 106, 108, 110, 112, 114 and 116 may operate at a single voltage or deferring voltages. In a preferred embodiment, the brake 106 operates at 10 volts, the headlight 108 operates at 8 volts, the tail light 110 operates at 6 volts, the left turn signal 112 operates at 4 volts, the right turn signal 114 also operates at 4 volts and the horn 116 operates at 12 volts.

The electrical power distribution module 104 is connected to and in communication with the battery 102 and the various accessories, 106, 108, 110, 112, 114 and 116. In particular, the control device (not shown but see FIG. 2) senses a battery signal from the battery 102 indicative of the battery voltage, via a battery sense line 142, and six accessory signals from six accessory modules (not shown but see FIG. 2) indicative of six accessory voltages, via six accessory sense lines 118, 122, 126, 130, 134 and 138, and converts the battery voltage to the six accessory voltages, via the voltage convertor module (not shown but see FIG. 2).

Accordingly, the electrical power distribution module 104 receives electrical power from the battery 102 on power line 144 at a voltage, for instance 100 volts, and delivers electrical power to the brake 106 at 10 volts, the headlight 108 at 8 volts, the tail light 110 at 6 volts, the left turn signal 112 at 4 volts, the right turn signal 114 also at 4 volts and the horn 116 at 12 volts on power lines 120, 124, 128, 132, 136 and 140, respectively.

FIG. 2 depicts a block diagram of an electrical power distribution module 200 according to a preferred embodiment. The electrical power distribution module 200 comprises a control device 202, a voltage convertor module 204 and six accessory modules M1, M2, M3, M4, M5 and M6, at 206, 208, 210, 212, 214 and 216, respectively.

The control device 202 senses a battery voltage from a battery, such as the battery 102 of FIG. 1, converts the battery voltage via the voltage convertor module 204 and delivers electrical power of the battery on a power line 218 to various accessories, such the accessories 106, 108, 110, 112, 114 and 116 of FIG. 1, via the accessory modules M1, M2, M3, M4, M5 and M6, at 206, 208, 210, 212, 214 and 216, respectively, at their corresponding voltages on power lines 220, 222, 224, 226, 228 and 230, respectively.

In a preferred embodiment, the control device 202 comprises a processor including a programming code stored on a storage device of said processor. The control device 202 may further comprise an analog to digital convertor (ADC) and a communication module. According to a preferred embodiment, the control device 202 is a 68HC08 processor having internal flash memory available from Freescale of Austin, Texas. It is contemplated that the processor may be a combination of individual discrete or separate integrated circuits packaged in a single housing or it may be fabricated in a single integrated circuit.

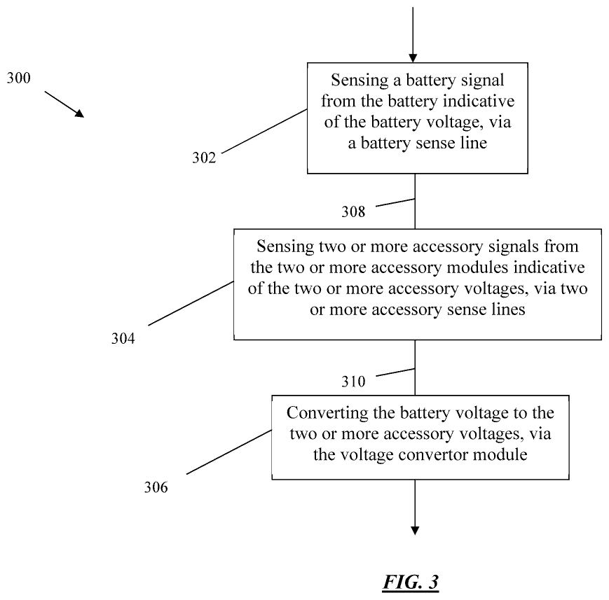

FIG. 3 depicts a flow diagram of one preferred method 300 of controlling an electric bicycle electrical system, such as the electrical system 100 of FIG. 1. According to this embodiment, the method comprises sensing a battery signal from the battery 102 indicative of the battery voltage, via the battery sense line 142, at 302. The method 300 further comprises of sensing six accessory signals from six accessory modules M1, M2, M3, M4, M5 and M6, at 206, 208, 210, 212, 214 and 216, respectively, indicative of the six accessory voltages, i.e., the brake 106 at 10 volts, the headlight 108 at 8 volts, the tail light 110 at 6 volts, the left turn signal 112 at 4 volts, the right turn signal 114 also at 4 volts and the horn 116 at 12 volts, via the six accessory sense lines 118, 122, 126, 130, 134 and 138, at 304. The method 300 further comprises converting the battery voltage to the six accessory voltages, via the voltage convertor module 204, at 306.

The foregoing explanations, descriptions, illustrations, examples, and discussions have been set forth to assist the reader with understanding this invention and further to demonstrate the utility and novelty of it and are by no means restrictive of the scope of the invention. It is the following claims, including all equivalents, which are intended to define the scope of this invention.

What is claimed is:

1. An electric bicycle electrical system comprising:
(a) a battery operative to provide electrical power at a battery voltage to the electrical system;
(b) two or more accessories; and
(c) an electrical power distribution module connected to and in communication with the battery and the two or more accessories, said electrical power distribution module comprising:
(i) a control device;
(ii) two or more accessory modules coupled with the two or more accessories and operative to provide electrical power to the two or more accessories at two or more accessory voltages; and
(iii) a voltage convertor module;
wherein the control device senses a battery signal from the battery indicative of the battery voltage, via a battery sense line, and two or more accessory signals from the two or more accessory modules indicative of the two or more accessory voltages, via two or more accessory sense lines, and converts the battery voltage to the two or more accessory voltages, via the voltage convertor module.

2. The electrical system of claim 1, wherein the control device comprises a microprocessor, including a programming code operable on the microprocessor.

3. The electrical system of claim 1, wherein the battery voltage is one of 48 volts, 52 volts, 60 volts, and 72 volts.

4. The electrical system of claim 1, wherein the two or more accessories comprise a head light, a tail light, a brake, a left turn signal, a right turn signal and a horn.

5. The electrical system of claim 4, wherein the two or more accessory modules provide electrical power to the head light at 8 volts, to the tail light at 6 volts, to the brake at 10 volts, to the left turn signal at 4 volts, to the right turn signal at 4 volts, and to the horn at 12 volts.

6. An electrical power distribution module for an electric bicycle electrical system, said electrical system comprising a battery operative to provide electrical power at a battery voltage to the electrical system and two or more accessories, wherein the electrical power distribution module is connected to and in communication with the battery and the two or more accessories, said electrical power distribution module comprising:
(i) a control device;
(ii) two or more accessory modules coupled with the two or more accessories and operative to provide electrical power to the two or more accessories at two or more accessory voltages; and
(iii) a voltage convertor module;
wherein the control device senses a battery signal from the battery indicative of the battery voltage, via a battery sense line, and two or more accessory signals from the two or more accessory modules indicative of the two or more accessory voltages, via two or more accessory sense lines, and converts the battery voltage to the two or more accessory voltages, via the voltage convertor module.

7. The electrical power distribution module of claim 6, wherein the control device comprises a microprocessor, including a programming code operable on the microprocessor.

8. The electrical power distribution module of claim 6, wherein the battery voltage is one of 48 volts, 52 volts, 60 volts, and 72 volts.

9. The electrical power distribution module of claim 6, wherein the two or more accessories comprise a head light, a tail light, a brake, a left turn signal, a right turn signal and a horn.

10. The electrical system of claim 9, wherein the two or more accessory modules provide electrical power to the head light at 8 volts, to the tail light at 6 volts, to the brake at 10 volts, to the left turn signal at 4 volts, to the right turn signal at 4 volts, and to the horn at 12 volts.

11. A method of controlling an electric bicycle electrical system, said electrical system comprising a battery operative to provide electrical power at a battery voltage to the electrical system, two or more accessories, and an electrical power distribution module connected to and in communication with the battery and the two or more accessories, said electrical power distribution module comprising a control device, two or more accessory modules coupled with the two or more accessories and operative to provide electrical power to the two or more accessories at two or more accessory voltages, and a voltage convertor module, said method comprising:
(i) sensing a battery signal from the battery indicative of the battery voltage, via a battery sense line;
(ii) sensing two or more accessory signals from the two or more accessory modules indicative of the two or more accessory voltages, via two or more accessory sense lines; and
(iii) converting the battery voltage to the two or more accessory voltages, via the voltage convertor module.

12. The method of claim 11, wherein the control device comprises a microprocessor, including a programming code operable on the microprocessor.

13. The method of claim 11, wherein the battery voltage is one of 48 volts, 52 volts, 60 volts, and 72 volts.

14. The method of claim 11, wherein the two or more accessories comprise a head light, a tail light, a brake, a left turn signal, a right turn signal and a horn.

15. The method of claim 14, wherein the two or more accessory modules provide electrical power to the head light at 8 volts, to the tail light at 6 volts, to the brake at 10 volts, to the left turn signal at 4 volts, to the right turn signal at 4 volts, and to the horn at 12 volts.
